(19) United States
(12) Patent Application Publication
(10) Pub. No.: US 2014/0176743 A1
(43) Pub. Date: Jun. 26, 2014

(54) METHOD, APPARATUS AND SYSTEM FOR PUBLISHING CREATIVE LOOKS AS THREE-DIMENSIONAL LOOKUP TABLES

(71) Applicant: THOMSON LICENSING, Issy de Moulineaux (FR)

(72) Inventors: Markus Eugen LOEFFLER, Altadena, CA (US); Joshua Pines, San Francisco, CA (US); Jed Harmsen, Los Angeles, CA (US)

(73) Assignee: THOMSON LICENSING, Issy de Moulineaux (FR)

(21) Appl. No.: 13/721,527

(22) Filed: Dec. 20, 2012

(51) Int. Cl. H04N 5/232

(52) U.S. Cl. CPC H04N 5/232
USPC 348/211.99

(57) ABSTRACT

Provided are a method, apparatus and system for publishing creative looks in a camera using three dimensional look-up tables. The system includes a user input device for defining a set of parameters directed to generating a creative look, a creative look generator for generating a respective three-dimensional lookup table for each set of defined parameters, each three-dimensional lookup table representing a respective creative look and a creative look publisher for enabling the selection of at least one creative look to be applied to at least one image captured by the camera.

### TECHNICAL FIELD

The present principles relate generally to image manipulation and, more particularly, to publishing creative looks as three-dimensional (3D) lookup tables in devices such as cameras.

### BACKGROUND

Consumer and professional still cameras and movie cameras have settings in which the user can adjust brightness, contrast, saturation, and sharpness. However, there is significant room for improvement in the implementations of these settings in such cameras. More specifically, the available settings in such available cameras are limited in their ability to provide the optimum resultant picture or movie.

### SUMMARY

These and other drawbacks and disadvantages of the prior art are addressed by the present principles, which are directed at least in part to publishing creative looks as three-dimensional (3D) lookup tables in cameras.

According to an embodiment of the present principles, there is provided a system for publishing creative looks in a camera. The system includes a user input device for receiving user inputs directed to generating the creative looks. The user inputs for each of the creative looks specify a respective title and at least one of set and modify at least one respective value for at least one respective parameter, applicable to at least one of an image still and a movie, and are thereafter associated with a particular one of the creative looks. The system further includes a creative look generator for generating the creative looks responsive to the user inputs. Each of the creative looks is generated in the form of a respective three-dimensional lookup table. The system also includes a creative look publisher for making the creative looks accessible through the camera to a camera user.

According to another embodiment of the present principles, there is provided a method for publishing creative looks in a camera. The method includes receiving user inputs directed to generating the creative looks. The user inputs for each of the creative looks specify a respective title and at least one of set and modify at least one respective value for at least one respective parameter, applicable to at least one of an image still and a movie, and are thereafter associated with a particular one of the creative looks. The method further includes generating the creative looks responsive to the user inputs. Each of the creative looks is generated in the form of a respective three-dimensional lookup table. The method also includes publishing the creative looks to the camera by making the creative looks accessible through the camera to a camera user. The creative look generator includes at least a processor.

According to yet another embodiment of the present principles, there is provided a computer readable storage medium including a computer readable program for publishing creative looks in a camera. The computer readable program when executed on a computer causes the computer to perform the following steps. In a step, user inputs are received directed to generating the creative looks. The user inputs for each of the creative looks specify a respective title and at least one of set and modify at least one respective value for at least one respective parameter, applicable to at least one of an image still and a movie, and are thereafter associated with a particular one of the creative looks. In another step, the creative looks are generated responsive to the user inputs. Each of the creative looks is generated in a form of a respective three-dimensional lookup table. In yet another step, the creative looks are published to the camera by making the creative looks accessible through the camera to a camera user.

These and other aspects, features and advantages of the present principles will become apparent from the following detailed description of exemplary embodiments, which is to be read in connection with the accompanying drawings.

### BRIEF DESCRIPTION OF THE DRAWINGS

The teachings of the present invention can be readily understood by considering the following detailed description in conjunction with the accompanying drawings, in which:

FIG. 1 depicts a high level block diagram of an apparatus for implementing the principles of the present invention, in accordance with an embodiment of the present invention;

FIG. 2 depicts a high level block diagram of an exemplary system for publishing creative looks as 3D lookup tables in a camera, in accordance with an embodiment of the present principles; and

FIG. 3 depicts a flow diagram of a method for publishing creative looks as 3D lookup tables in a camera, in accordance with an embodiment of the present principles.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION

The present invention advantageously provides a method, apparatus and system for publishing creative looks as three-dimensional (3D) lookup tables (LUTs) in cameras. Although the present invention will be described primarily within the context of using a modified version of our own (TECHNICOLOR™) color correction application (DP LIGHTS™ MOBILE), a camera, and an application to upload the creative looks (embodied as 3D LUTs) back into the camera, the specific embodiments of the present invention should not be treated as limiting the scope of the invention. It will be appreciated by those skilled in the art and informed by the teachings of the present invention that the concepts of the present invention can be implemented using other applications to enable the creation of creative looks in other image devices, such as mobile devices such as mobile phones in accordance with the present principles while maintaining the spirit of the present invention.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

In accordance with an embodiment of the present principles, a method, apparatus and system are provided for publishing creative looks as three-dimensional (3D) lookup tables (LUTs) in cameras. As used herein, the phrase “creative looks” refers to the application of at least one of primary and secondary color correction to obtain a specific desired result with respect to a still image or movie to which a particular creative look is applied. In further detail, primary color correction involves the entirety of an image utilizing control over intensities of red, green, blue, gamma (mid tones), highlights (whites) and shadows (blacks). Secondary color correction isolates a range of color, saturation and brightness values to cause alterations in luminance, saturation, and hue in only the isolated range, while minimally or not at all affecting the rest of the color spectrum.

Recently a new digital single lens reflex (DSLR) camera was released which included “picture-styles”. These picture styles included more sophisticated controls over the image than the aforementioned prior art. The picture styles were basically 1dimensional curves which the user could modify using an application provided by the camera manufacturer. These picture styles could then be published in the camera. Before recording still pictures and/or movies, the user could select a picture style used for the shoot.

Advantageously, in an embodiment of the present invention a 3D look-up table (LUT) is uploaded into a camera to generate creative looks for images. That is, a 1D LUT is a one-dimensional data structure that includes an input entry and a corresponding output entry. Typically for color manipulation of images, there is a set of three 1D LUTs required, one for each of the R,G,B color channels. In accordance with various embodiments of the present invention, a 3D LUT is a three-dimensional data structure that includes input entries and corresponding output entries. In accordance with various embodiments of the present invention, a 3D LUT comprises at least six columns; three input columns and three output columns. A 3D LUT of the present invention defines for each input RBG color triple an output triple. Thus, using a single 3D LUT in accordance with the embodiments of the present invention allows for more information to be obtained relating to each of the three color channels. That is, using a 3D LUT in accordance with the embodiments of the present invention a user can adjust brightness, contrast, saturation, sharpness and other parameters of images with more detail or can adjust more image parameters in a single setting or style. With the use of 3D LUTs in accordance with the present invention, the quality and variety of creative looks is much superior then with former used methods using 1D parameters. Further, in accordance with the various embodiments of the present invention, an application is then provided to produce creative looks using 3D LUTs and to publish them back into the camera.

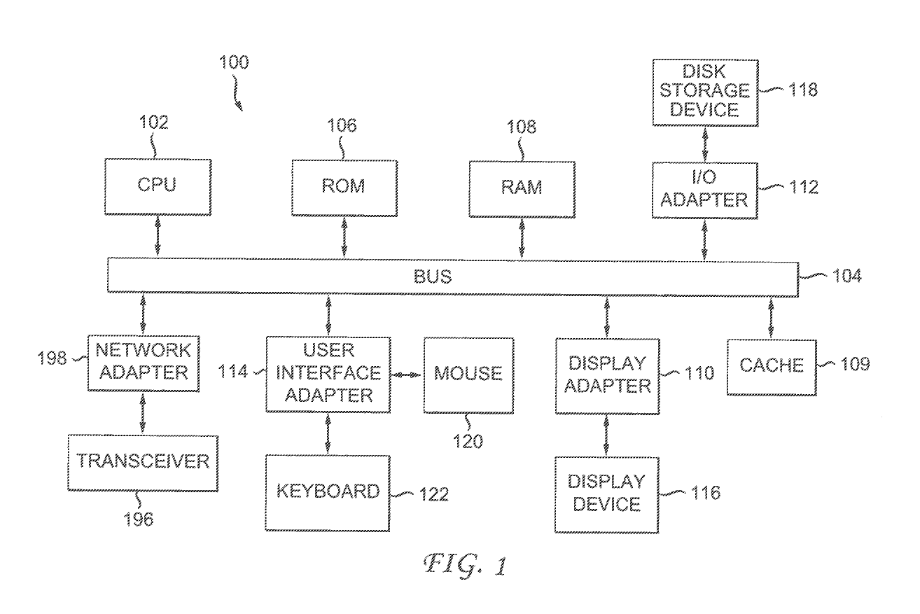

FIG. 1 depicts a high level block diagram of an exemplary processing apparatus 100 for implementing the principles of the present invention, in accordance with an embodiment of the present invention. The processing apparatus 100 of FIG. 1 includes at least one processor (CPU) 102 operatively coupled to other components via a system bus 104. A read only memory (ROM) 106, a random access memory (RAM) 108, a display adapter 110, an input/output (I/O) adapter 112, a user interface adapter 114, and a network adapter 198, are operatively coupled to the system bus 104.

In the system of FIG. 1, a display device 116 is operatively coupled to the system bus 104 by display adapter 110. A disk storage device (e.g., a magnetic or optical disk storage device) 118 is operatively coupled to the system bus 104 by the I/O adapter 112. A mouse 120 and keyboard 122 are operatively coupled to the system bus 104 by the user interface adapter 214. The mouse 120 and keyboard 122 are used to communicate information with the system 100. In the embodiment of FIG. 1, a transceiver 196 is operatively coupled to the system bus 104 by a network adapter 198.

The system 100 may also include other elements (not shown), as readily contemplated by one of skill in the art, as well as omit certain elements. For example, various other input devices and/or output devices can be included in the system 100, depending upon the particular implementation of the same, as readily understood by one of ordinary skill in the art. For example, various types of wireless and/or wired input and/or output devices can be used for communication with, for example, a camera. Moreover, additional processors, controllers, memories, and so forth, in various configurations can also be utilized as readily appreciated by one of ordinary skill in the art. These and other variations of the apparatus 100 of FIG. 1 are readily contemplated by one of ordinary skill in the art given the teachings of the present principles provided herein.

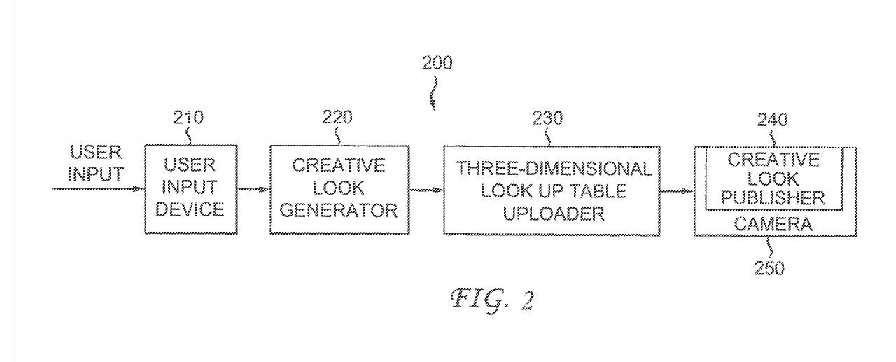

Although the processing apparatus of FIG. 1 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software executed by a processor, hardware, or a combination thereof. In addition, the processing apparatus of FIG. 1 is depicted as a separate component, the functionalities of the server in accordance with the concepts and embodiments of the present invention described herein can be incorporated into an existing system component of, for example, the system 200 of FIG. 2.

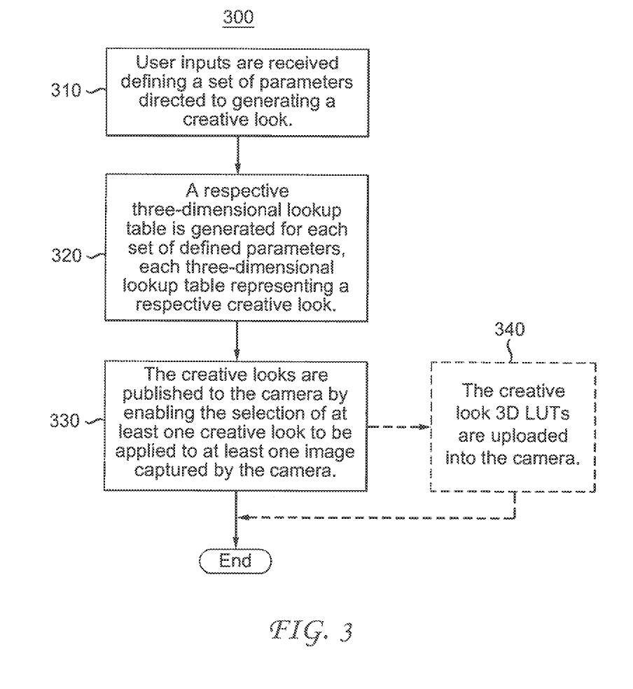

More specifically, system 200 described below with respect to FIG. 2 is a system for implementing respective embodiments of the present principles. Part or all of processing apparatus 100 may be implemented in one or more of the elements of system 200 of FIG. 2. Further, it is to be appreciated that processing apparatus 100 may perform at least part of the method described herein including, for example, at least part of method 300 of FIG. 3. Similarly, part or all of system 200 may be used to perform at least part of method 300 of FIG. 3.

FIG. 2 depicts a high level block diagram of an exemplary system 200 for publishing creative looks as 3D lookup tables in a camera, in accordance with an embodiment of the present principles. The system 200 of FIG. 2 includes a user input device 210 and a creative look generator 220. The system 200 interfaces with a camera 250 in order to enable the publishing of the creative looks in the camera in accordance with embodiments of the present invention, as described in further detail herein below.

In the embodiment of FIG. 2, the user input device 210 is used by a user to define at least one set of parameters directed to generating at least one creative look. In an embodiment, the user inputs, for each creative look, include, but are not limited to, a creative look title and one or more values for one or more parameters that are set and/or otherwise modified to achieve that creative look. The one or more parameters specified for each creative look are parameters applicable to an image still and/or a movie, and are thereafter associated with a particular one of the creative looks along with the corresponding title for that creative look.

In one embodiment of the present invention, the user inputs, that is, the one or more parameters, are directed to primary color correction and/or secondary color correction. That is in one embodiment of the present invention, the one or more parameters can be directed to control over intensities of red, green, blue, gamma (mid tones), highlights (whites) and shadows (blacks) with respect to an entire image and/or control over a particular range of color, saturation and brightness values to cause alterations in luminance, saturation, and hue in only that particular range. It is to be appreciated that the preceding list of parameters is merely illustrative and not exhaustive. That is, given the teachings of the present principles provided herein, one of ordinary skill in the art will readily contemplate these and various other parameters that can be used to generate creative looks, while maintaining the spirit of the present principles. It is to be appreciated that such user inputs can be directed to two-dimensional and/or three-dimensional representations of any resultant picture or movie to which the creative look is applied, depending upon the implementation. Thus, some of the parameters can be directed to three-dimensional parameters.

Referring back to FIG. 2, the creative look generator 220 generates respective three-dimensional lookup tables for each set of defined parameters, each three-dimensional lookup table representing a respective creative look. That is, in an embodiment of the present invention, a creative look is generated in response to user inputs/preferences. In the embodiment of FIG. 2, each of the creative looks is generated in the form of a respective three-dimensional lookup table.

Although in the embodiment of the system 200 of FIG. 2 the user input device 210 and the creative look generator 220 are depicted as separate elements, in alternate embodiments of the present invention, the creative look generator 220 can include the user input device 210 and/or be part of the same overall device. For example, both the user input device 210 and the creative look generator 220 can be embodied in a processing apparatus such as the apparatus 100 described above with respect to FIG. 1.

The system 200 of FIG. 2 illustratively further includes an optional 3D LUT up-loader 230 for uploading the creative look 3D LUTs into the camera 250. Alternatively, the creative look generator 220 can be configured to interface with an existing 3D LUT up-loader to upload the creative look 3D LUTs into the camera 250. In one embodiment of the present invention, the 3D LUT up-loader 230 can comprise a special purpose cable or an existing cable, or can be implemented using wireless technology. For example, in the case of BLUETOOTH enabled cameras, the 3D LUT up-loader 230 can use BLUETOOTH technology to upload the 3D LUTs into the camera 250. Of course, other wireless technologies can also be used in accordance with the principles of the present invention.

In an alternate embodiment of the present invention, the 3D LUT up-loader 230 can be more advanced than simply a cable and/or wireless transmission device, as readily appreciated by one of ordinary skill in the art, given the teachings of the present principles provided herein. For example, the 3D LUT up-loader 230 of an embodiment of the present invention can be specially configured to interface with specific cameras and/or specific functions of specific cameras in order to obtain the best advantage depending upon the specific implementation and the specific camera in which the 3D LUTs are used. These and other variations of the 3D LUT up-loader 230 are readily contemplated by one of ordinary skill in the art, given the teachings of the present principles provided herein.

In the embodiment of FIG. 2, a creative look publisher 240 publishes (e.g., makes available through an application and/or user interface of the camera 250) the creative looks in the camera. That is, the creative look publisher 240 enables the selection of at least one creative look to be applied to at least one image. In an embodiment of the present invention, the creative look publisher 240 can be an application and/or user interface (e.g., a graphical user interface (GUI), or other type of interface) that is uploaded along with the 3D LUTs or alternatively can be an existing application or interface on the camera 250, through which a particular creative look from among a group of available creative looks is capable of being selected.

It should be noted that in the embodiment of FIG. 2, the camera 250 is not to be considered part of system 200, but simply the end device that gains the advantage of the output of system 200, namely the creative look 3D LUTs. In alternate embodiments of the present invention, a system of the present invention can include other elements (not shown), as readily contemplated by one of skill in the art, as well as omit certain elements. These and other variations of the system 200 are readily contemplated by one of ordinary skill in the art given the teachings of the present principles provided herein.

FIG. 3 depicts a flow diagram of an exemplary method 300 for publishing creative looks as 3D lookup tables in a camera, in accordance with an embodiment of the present principles.

The method 300 begins at step 310 during which user inputs are received directed to generating creative looks (e.g., via the user input device 210). More specifically, in the embodiment of FIG. 3 at step 310 user inputs are received defining a set of parameters directed to generating a creative look. Thus, in an embodiment, for a particular creative look to be generated, the user inputs can be directed to a respective title of a given creative look, and one or more values for one or more parameters applicable to at least one of an image still or a movie, with the title and the one or more values for the one or more parameters being thereafter associated with that particular creative look. Thus, it is to be appreciated that in various embodiments of the present invention these user inputs are not provided in the typical manner where a single parameter is merely adjusted. Rather, in an embodiment, for each creative look to be subsequently generated in the next step (step 320), a creative look title is specified along with one or more values for one or more parameters that are set and/or otherwise modified in order to achieve that creative look. As noted above, the parameters can be directed to primary color correction and/or secondary color correction in which primary color correction involves utilizing control over intensities of red, green, blue, gamma (mid tones), highlights (whites) and shadows (blacks) of an entire image and secondary color correction isolates a range of color, saturation and brightness values to cause alterations in luminance, saturation, and hue in only the isolated range, while minimally or not at all affecting the rest of the color spectrum. That is, using a 3D LUT in accordance with the embodiments of the present invention a user can adjust brightness, contrast, saturation, sharpness and other parameters of images with more detail or can adjust more image parameters in a single setting or style. With the use of 3D LUTs in accordance with the present invention, the quality and variety of creative looks is much superior then with former used methods using 1D parameters.

For example, in an embodiment of the present invention, user inputs are provided so as to generate a group of creative looks having different parameters (or different values for one or more of the same parameters) with respect to each other, so that a user can select a particular creative look from among the group of creative looks in order to have that particular creative look applied to any subsequent image still(s) and/or movie(s) captured by the camera. This selection and reproducibility of the creative looks is enabled by the publishing step (step 340 herein below) and allows the creative looks to be reproducible on demand by the camera user (by simply selecting a particular creative look) depending on the camera user's particular requirements and/or preferences for a given image still(s) and/or movie(s). The method 300 then proceeds to step 320.

At step 320, creative looks are generated responsive to the user inputs, for example via the creative look generator 220. More specifically, in the embodiment of FIG. 3, at step 320 a respective three-dimensional lookup table is generated for each set of defined parameters, each three-dimensional lookup table representing a respective creative look. That is, in an embodiment, the creative looks are generated in the form of three-dimensional lookup tables. Such 3D LUTs can take the forms of, but are not limited to, three-dimensional data structures such as an array or an associative array, a list, and forth, as readily understood by one of ordinary skill in the art. The method 300 then proceeds to step 330.

At step 330, the creative looks are published (e.g., made available through an application and/or user interface of the camera 250 via creative look publisher 240) so that a camera user can select a particular creative look from among a group of creative looks in order to apply the particular selected creative look to any subsequent image still(s) or movie(s) captured by the camera. More specifically, in the embodiment of FIG. 3, the creative looks are published to the camera by enabling the selection of at least one creative look to be applied to at least one image captured by the camera. The method 300 can then be exited or proceeds to optional step 340.

At optional step 340, the creative look 3D LUTs are uploaded into a camera 250, for example via the 3D LUT up-loader 230. The method 300 can then be exited.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Having described various embodiments for a method, apparatus and system for publishing creative looks as three-dimensional (3D) lookup tables (LUTs) in cameras (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A system for publishing creative looks in a camera, comprising:
a user input device for defining a set of parameters directed to generating a creative look;
a creative look generator for generating a respective three-dimensional lookup table for each set of defined parameters, each three-dimensional lookup table representing a respective creative look; and
a creative look publisher for enabling the selection of at least one creative look to be applied to at least one image captured by the camera.

2. The system of claim 1, further comprising a three-dimensional lookup table loader for uploading a respective three-dimensional lookup table for each of the creative looks into the camera.

3. The system of claim 1, wherein the creative looks are published using at least one of an application and a user interface.

4. The system of claim 3, wherein the at least one of the application and the user interface provide a camera user a capability to select a given particular creative look from among a plurality of creative looks, wherein a selection of the given particular creative look constrains the camera to apply the given particular creative look to at least one a still image and a video captured using the camera.

5. The system of claim 1, wherein the creative looks are reproducible from the camera upon being published in the camera.

6. The system of claim 1, wherein the set of parameters is directed to at least one of primary color correction and secondary color correction.

7. The system of claim 1, wherein for each of the creative looks, the set of parameters correspond to at least one of user specified requirements and user specified preferences for the at least one of a still image and video captured.

8. The system of claim 1, wherein the set of parameters relates to at least one of a still image or video in a two-dimensional form.

9. The system of claim 1, wherein the set of parameters relates to at least one of a still image or video in a three-dimensional form.

10. A method for publishing creative looks in a camera, comprising:
receiving user inputs defining a set of parameters directed to generating a creative look;
generating a respective three-dimensional lookup table for each set of defined parameters, each three-dimensional lookup table representing a respective creative look; and
publishing the creative looks to the camera by enabling the selection of at least one creative look to be applied to at least one image captured by the camera.

11. The method of claim 10, further comprising uploading a respective three-dimensional lookup table for each of the creative looks into the camera.

12. The method of claim 10, wherein the creative looks are published using at least one of an application and a user interface.

13. The method of claim 12, wherein the at least one of the application and the user interface provide a camera user a capability to select a given particular creative look from among a plurality of creative looks, wherein a selection of the given particular creative look constrains the camera to apply the given particular creative look to at least one of any image stills and any videos captured using the camera.

14. The method of claim 10, wherein the creative looks are reproducible from the camera upon being published in the camera.

15. The method of claim 10, wherein the set of parameters is directed to at least one of primary color correction and secondary color correction.

16. The method of claim 10, wherein the set of parameters includes at least a respective title for a respective creative look and at least a value for defining at least one of a brightness, contrast, saturation, sharpness and color of an image.

17. An apparatus for publishing creative looks in a camera, comprising:
a memory for storing at least program routines and data; and
a processor for executing said program routines;
said apparatus configured to:
receive user inputs defining a set of parameters directed to generating a creative look;
generate a respective three-dimensional lookup table for each set of defined parameters, each three-dimensional lookup table representing a respective creative look; and
publish the creative looks to the camera by enabling the selection of at least one creative look to be applied to at least one image captured by the camera.

18. The apparatus of claim 17, wherein said apparatus comprises an integrated component of at least one of a creative look generator, a creative look publisher and a three-dimensional lookup table loader.

19. A computer readable storage medium comprising a computer readable program for publishing creative looks in a camera, wherein the computer readable program when executed on a computer causes the computer to perform the steps of:
receiving user inputs defining a set of parameters directed to generating a creative look;
generating a respective three-dimensional lookup table for each set of defined parameters, each three-dimensional lookup table representing a respective creative look; and
publish the creative looks to the camera by enabling the selection of at least one creative look to be applied to at least one image captured by the camera.

20. The computer readable storage medium of claim 19, wherein the set of parameters is directed to at least one of primary color correction and secondary color correction.
